(19) United States
(12) Patent Application Publication
(10) Pub. No.: US 2006/0080149 A1
(43) Pub. Date: Apr. 13, 2006

(54) Healthcare guidance support system

(75) Inventors: Hidekatsu Takada, Fujimi (JP); Takanobu Osaki, Kokubunji (JP); Hideyuki Ban, Kodaira (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 11/195,686

(22) Filed: Aug. 3, 2005

(30) Foreign Application Priority Data
Oct. 7, 2004 (JP) 2004-294430

(51) Int. Cl. G06F 19/00

(52) U.S. Cl. 705/3

(57) ABSTRACT

A health guidance support system for examinee's health improvement including a health checkup data storage for examinees' data containing levels of health conditions or development of diseases and related risk data collected at a certain time interval, an input unit for a health level and risk data in the present user's condition and a future target level, an extraction unit to extract checkup data satisfying the health level and risk data in the user's present condition at a preceding time point as a first data group and checkup data contained therein and satisfying a target health level at a subsequent time point as a second data group, a computing unit to compute an attainment level of the target health level corresponding to a combination of the risk data at the subsequent time point based on both data groups, and a display unit for the combination and attainment level is provided.

### CLAIM OF PRIORITY

The present application claims priority from Japanese application JP 2004-294430 filed on Oct. 7, 2004, the content of which is hereby incorporated by reference into this application.

### FIELD OF THE INVENTION

The present invention relates to a healthcare guidance support system to support healthcare guidance conducted for an examinee based on his/her health checkup results.

### BACKGROUND OF THE INVENTION

In recent years, life style diseases such as diabetes, hypertension, and hyperlipidemia have been emerging as a major health problem. With an aim to screen and prevent diseases represented by the life style diseases, periodical physical examination (hereinafter, referred to as health checkup) is carried out in workplaces and local communities.

Life style diseases are considered to be greatly influenced by content of meals, amount of exercise, and the like associated with each individual over a long time period, and commonly develop without having appreciable subjective symptoms. However, it is also possible to prevent development of the diseases by improving life style appropriately. Therefore, it is becoming more and more important for health checkup services to improve service for examinees to promote their health by providing health guidance based on individual health checkup results and the like.

For example, a technology in which various checkup items and interview items are indexed based on a table prepared in advance using average levels and the like of individual items of health checkup results that have been input and the contents of health guidance are prepared on the basis of the indexed results is disclosed (for example, refer to Patent Document 1; JP No. 2582203).

### SUMMARY OF THE INVENTION

In health guidance, general and uniform guidance for life style, for example, “Let's reduce body weight”, “Let's refrain from smoking”, and “Let's increase exercise”, is often provided. In significant cases, the content of the guidance is general one as described above, and its ground is not indicated, thus presenting a problem that the guidance does not always bring about improvement in health. On the other hand, a quantitative analysis with actual data has been difficult in acquiring a large volume of health checkup results (hereinafter, referred to as health checkup information) and conducting follow-up studies. Accordingly, specific guidance on how much weight should be decreased or how much exercise should be increased has remained difficult.

An object of the present invention is to provide a health guidance support system that offers objective and specific information useful for improvement of health condition of an examinee.

A first configuration of the health guidance support system of the present invention is provided with a health checkup data storage to store health checkup data of a plurality of examinees containing health levels concerned with health conditions or development of diseases and risk data concerned with one or more kinds of risks having an influence on the health conditions or the diseases, an input unit to input a health level and risk data in the present condition of a user and a future target health level of the health level, a computing unit to compute an attainment level of the target health level, and a display unit to display a combination and attainment level. With the use of health checkup data at a preceding time point and a subsequent time point with a certain time interval between them, the extraction unit extracts the health checkup data satisfying the health level and risk data in the present condition of the user at the preceding time point as a first group of data and the health checkup data contained in the first group of data and satisfying the target health level at the subsequent time point as a second group of data. The computing unit computes the attainment level of the target health level corresponding to the combination of risk data at the subsequent time point based on the first group of data and the second group of data. The combination and the attainment level are displayed on the display unit.

In more detail, in the first configuration of the system of the present invention, the above problem is solved by the following composition.

(1) The health level includes laboratory data of examination items relating to health conditions or development of diseases and makes use of laboratory results of the examination items utilized for screening of diseases and the like.

(2) The risk includes laboratory data of second examination items that influence health conditions and diseases but are different from the above examination items and makes use of examination items such as body weight that influencea plurality of diseases in a complex manner.

(3) The risk includes life style that influences the health conditions or the diseases and makes use of life style information commonly collected through interview at the time of health checkup.

(4) The diseases include life style diseases caused by life style, and life style diseases that are currently matters of concern are particularly included.

(5) The attainment level is a ratio of the number of examinees satisfying the combination of the first group of data to the number of examinees satisfying the combination of the second group of data. It simply presents to a user an actual data on what percentage of examinees showed improvement among the examinees who changed their life style and the like in the past.

(6) The number of examinees satisfying the combination of the first group of data and the number of examinees satisfying the combination of the second group of data are displayed at the same time. The actual improvement data of the examinees who changed their life style and the like in the past is simply presented to the user by showing from what data and ground the data is extracted.

(7) Information relating to changes from the risk data in the present condition of the user to the risk data constituting the combination is automatically displayed. What action is required to change the laboratory data such as weight and the life style to a displayed level is simply offered to the user.

A second configuration of the health guidance support system of the present invention is provided with a health checkup data storage to store health checkup data of a plurality of examinees that contains health levels concerned with health conditions or development of diseases and risk data concerned with one or more kinds of risks having an influence on health conditions or diseases, an input unit to input a health level and risk data in the present condition of a user, a future target health level of the health level, and future target risk data of the risk data, an extraction unit to extract data, a computing unit to compute an attainment level of the target health level, and a display unit to display attainment levels. With the use of health checkup data at a preceding time point and a subsequent time point with a certain time interval between them, the extraction unit extracts the health checkup data that satisfies the health level and risk data in the present condition of the user at the preceding time point as well as the target risk data at the subsequent time point as a first group of data and the health checkup data that is contained in the first group of data and satisfies the target health level at the subsequent time point as a second group of data. The computing unit computes an attainment level of the target health level based on the first group of data and the second group of data.

In more detail, in the second configuration of the system of the present invention, the above problem is solved by the following composition.

(a) The attainment level is a ratio of the number of examinees of the first group of data to the number of examinees of the second group of data. It simply presents to a user an actual data on what percentage of examinees showed improvement in the past.

(b) The number of examinees of the first group of data and the number of examinees of the second group of data are displayed at the same time. The actual improvement data of the examinees in the past is simply presented to the user by showing from what data and ground the data is extracted.

(c) Information relating to changes from the risk data in the present condition of the user to the target risk data is automatically displayed. What action is required to change the laboratory data such as weight and the life style to a target level is simply offered to the user.

According to the health guidance support system of the present invention, it is possible to support health guidance by an advising doctor as well as to support target setting of life style by an examinee, and strong awareness of life style improvement of the examinee can be boosted. Further, the health guidance support system that supports disease prevention and health promotion more effectively can be provided by offering an individual health management program based on actual data and the like.

### BRIEF DESCRIPTION OF THE DRAWINGS

FIG. 1 is a diagram showing a configuration example of a system of an embodiment of the present invention;

FIG. 2 represents an example of data configuration of health checkup data in the embodiment of the present invention;

FIG. 3 is a diagram showing a screen example of an input/output terminal at the time of initiating an operation of the system of the embodiment of the present invention;

FIG. 4 is a flow chart showing a process of the system of the embodiment of the present invention;

FIG. 5 is a diagram showing a screen example of the input/output terminal at the time of inputting conditions in the embodiment of the present invention;

FIG. 6 represents an example of data extraction in the embodiment of the present invention;

FIG. 7 is a diagram explaining a concept of the data extraction in the embodiment of the present invention;

FIG. 8 is a diagram showing a display example of results obtained by the system of the embodiment of the present invention;

FIG. 9 is a diagram showing another display example of results obtained by the system of the present invention; and

FIG. 10 is a diagram showing still another display example of results obtained by the system of the embodiment of the present invention.

### DETAILED DESCRIPTION OF THE PREFERRED EMBODIMENTS

Hereinafter, embodiments of the present invention are explained in detail with reference to the accompanying drawings. It should be noted that a healthcare guidance support system 100 is referred to as “system” in the following explanation. Further, the current level of laboratory data for examinee is referred to as “current level of laboratory data”, and the future target level (targeted level) of laboratory data for examinee is referred to as “target level of laboratory data”. The current level of life style of examinee is referred to as “current level of life style”, and the future target level (targeted level) of life style of examinee is referred to as “target level of life style”. Other laboratory data and life style are referred to as “other items”, the current level of other laboratory data and life style information is referred to as “current level of other items”, and the future level of other laboratory data and life style information is referred to as “target level of other items”.

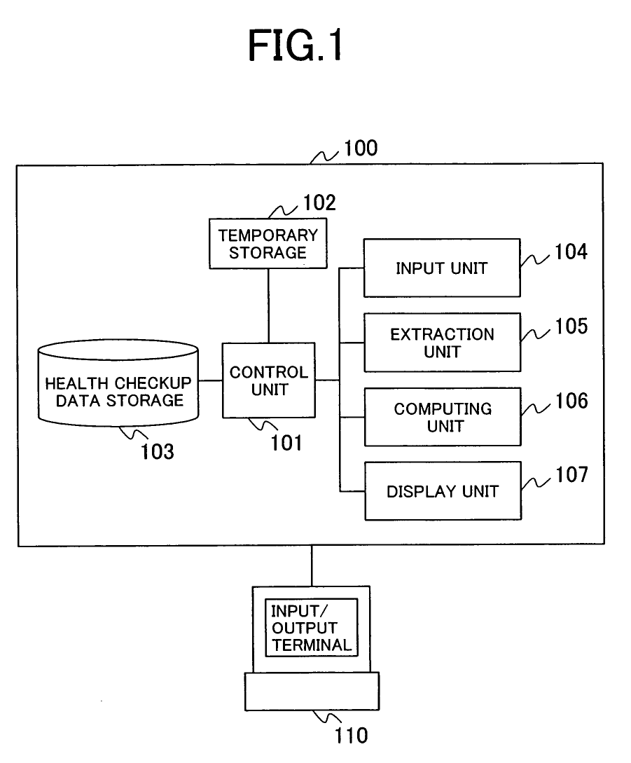

FIG. 1 is a diagram showing a configuration example of a system of the embodiment of the present invention.

The system shown in FIG. 1 is composed of a control unit 101, a temporary storage 102, a health checkup data storage 103, an input unit 104, an extraction unit 105, a computing unit 106, and a display unit 107. The system is described as a hardware configuration, while the function of the system may also be composed of software. Although information equipment such as personal computer having a keyboard and mouse as an input function and a CRT display as an output function is exemplified for an input/output terminal 110 connected to the system, other input/output functions may be provided. Note that the input/output function of the input/output terminal 110 may be mounted in the system.

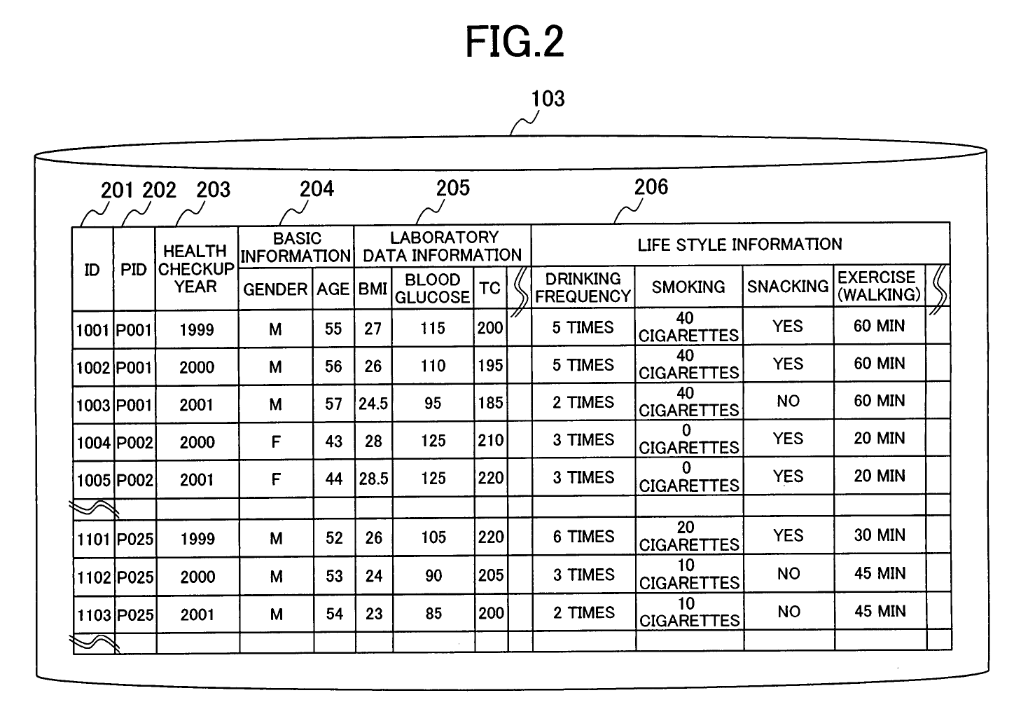

FIG. 2 represents an example of data configuration of past health checkup data on a plurality of examinee that is stored in the health checkup data storage 103 in the embodiment of the present invention.

The health checkup data stored in the health checkup data storage 103 is composed of ID data 201 storing ID to identify each health checkup data, examinee ID data 202 storing examinee ID to identify each examinee, examination year data 203 storing examination year, basic information data 204 storing basic information on each examinee, laboratory data information data 205 storing laboratory data information on each examinee, and life style information data 206 storing life style information of each examinee.

In the example shown in FIG. 2, gender and age for the basic information data 204, body mass index (BMI), blood glucose, total cholesterol (TC), and the like for the laboratory data information data 205, and drinking frequency and number of cigarettes smoked per week, snacking or no snacking, exercise time (walking), and the like for the life style information data 206 are stored, respectively. In the basic information data 204, marital status, personal medical history, history of present illness, family medical history, and the like may also be included. In the laboratory data information data 205, laboratory data such as sugar urine, HbAlc, triglyceride, HDL-cholesterol, and LDL-cholesterol may also be included. In the life style information data 206, sleeping hours, eating habit, exercise habit, and the like may also be included as life style information of examinee.

Annual change of laboratory data and life style of the same examinee can be extracted based on the health checkup data stored in the health checkup data storage 103. For example, it is found in the example shown in FIG. 2 that the laboratory data of the examinee with ID=P001 has changed in BMI (27→26→24.5), blood sugar (115→110→95), and TC (200→195→185) over the years from 1999 to 2001, respectively. It is also found that the examinee with ID=P001 had a life style of “drinking 5 times per week” and “snacking” in 2000, while it changed to “drinking twice per week” and “no snacking”, respectively, in 2001.

Generally, diseases such as life style diseases are screened by the use of specific laboratory data in many cases. For example, the onset of diabetes is often diagnosed when the criteria for blood glucose level (fasting blood glucose level) of 120 or higher are met. When the level is close to that level despite being lower than 120, the case is often regarded as a warning condition for the onset of diabetes. Similarly, hypertension is screened by blood pressure, hyperlipidemia by TC, obesity by BMI, and so on. For prevention of the onsets of these diseases, it is important to maintain their related laboratory data at an appropriate level. Therefore, healthcare guidance after health checkup is provided in such a way as “suspected of diabetes because of high blood glucose level”, “cautious of heperlipidemia because of relatively high TC level”, and the like using the laboratory data in many cases.

In the embodiment of the present invention, it makes possible to support healthcare guidance by an advising doctor as well as goal setting of life style by an examinee by presenting an indicator showing that “how far this goal is attained by how much change in life style” with an aim to change laboratory data related to diseases mainly such as life style diseases to appropriate levels in future based on healthcare checkup data accumulated from past to present.

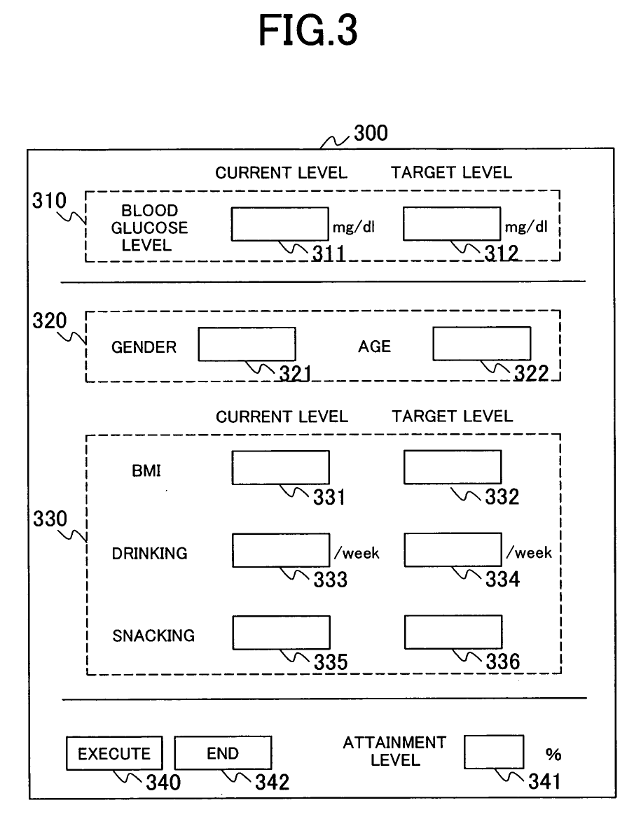

FIG. 3 is a diagram showing a screen example 300 of the input/output terminal 110 at the time of initiating an operation of the system of the embodiment of the present invention. In FIG. 3, an example aiming at improving diabetes is shown.

The screen example 300 includes an input region for laboratory data 310, an input region for basic information 320, an input/output region for other items 330, an execute button 340, an output column for attainment level 341, and an end button 342. The input region for laboratory data 310 includes a current level and a target level of laboratory data. In the screen example 300, columns 311 and 312 to input the current level and the target level, respectively, for the blood glucose level used in diabetes screening are displayed. The input region for basic information 320 includes a column to input basic information. In the screen example 300, columns 321 and 322 to input the gender and age of an examinee, respectively, are displayed. The input/output region for other items 330 includes columns to input and output the present level (current level) and the future target level (target level) of laboratory data besides the above target laboratory data and life style information. In the screen example 300, columns 331 to 336 to input or output the current levels and the target levels with respect to BMI, drinking habit, and snacking habit, respectively, are displayed.

Although blood glucose level is used as the laboratory data for diabetes in FIG. 3, other laboratory data such as sugar urine and HbAlc may also be used. A plurality of these data may also be used at the same time as the laboratory data. Further, BMI, drinking, and snacking are used for other items in FIG. 3. However, all other information contained in the health checkup data storage 103 may also be used. Improvement of a health condition of diabetes is aimed at in the example shown in FIG. 3, while the screen may be configured to aim at improving health conditions of other life style diseases such as hypertension and hyperlipidemia, and other diseases. In this case, it is needless to say that other items are modified depending on each disease. In the case of hypertension for example, blood pressure as the laboratory data and whether or not sodium-rich meals are frequently taken and so forth as other items are conceivable. In the case of hyperlipidemia, TC as the laboratory data and whether or not oil-rich meals are frequently taken and so forth as other items are conceivable.

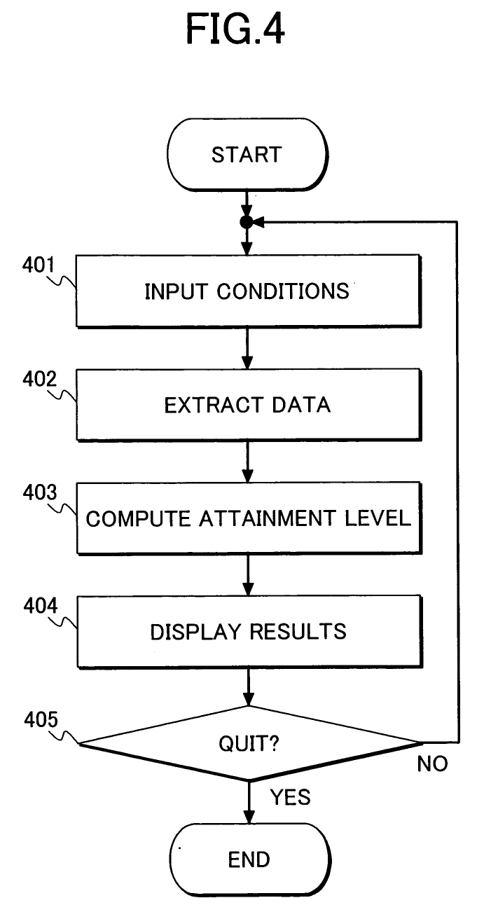

FIG. 4 is a flow chart showing a process of the system of the embodiment of the present invention.

When the system starts its operation, the control unit 101 activates the input unit 104 and invokes a step of inputting conditions 401 to accept a user's input. In the step 401, a screen such as the screen example 300 is displayed on the input/output terminal 110, and the user inputs respective values in the column to input the current level of laboratory data 311, the column to input the target level of laboratory data 312, the column to input gender 321, and the column to input age, and with respect to other items, the column to input the current level of BMI 331, the column to input the current level of drinking frequency 333, and the column to input the current level of snacking 335.

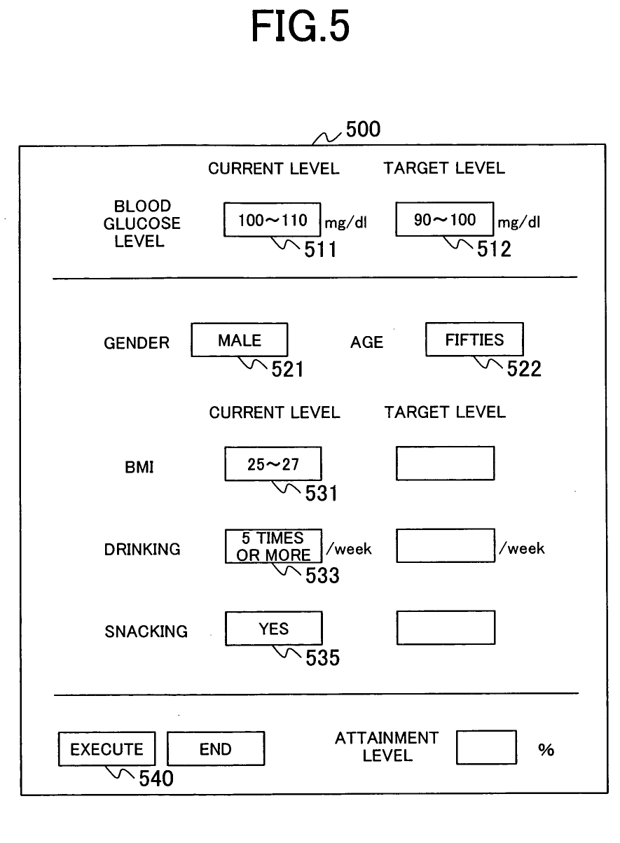

FIG. 5 is a diagram showing a screen example of the input/output terminal at the time of inputting conditions in the embodiment of the present invention. FIG. 5 depicts a screen example 500 of the input/output terminal 110 at the time when the user inputs values in each column after having executed the step 401.

In the screen example 500, a current level of 100 to 110 mg/dl (511) and a target level of 90 to 100 mg/dl (512) for blood glucose level concerning diabetes, gender of male (512), age in fifties (522), and BMI of 25 to 27 (531), drinking frequency of 5 days or more per week (533) and snacking (535) for the current levels of other items are input. When the user press an execute button 540 in the screen example 500, the control unit 101 activates the extraction unit 105 to extract data from the health checkup data storage 103 under various conditions and performs a step of extracting data 402 to store the extracted results in the temporary storage 102. Next, the control unit 101 activates the computing unit 106 and performs a step of computing attainment levels 403 in which attainment levels for every condition are computed based on the extracted results stored in the temporary storage 102 at the step 402, and the results are stored in the temporary storage 102.

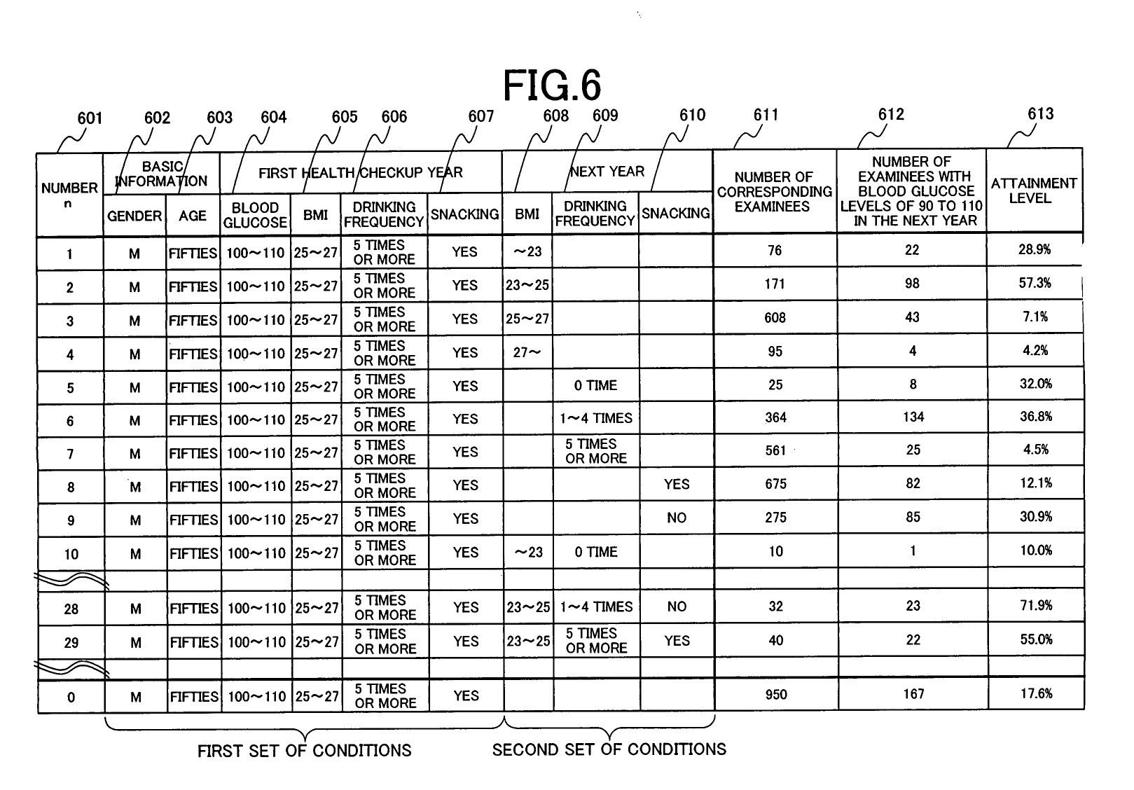

FIG. 6 represents an example of data extraction in the embodiment of the present invention, where the extracted results and the attainment levels stored in the temporary storage 102 at the respective steps 402 and 403 are shown.

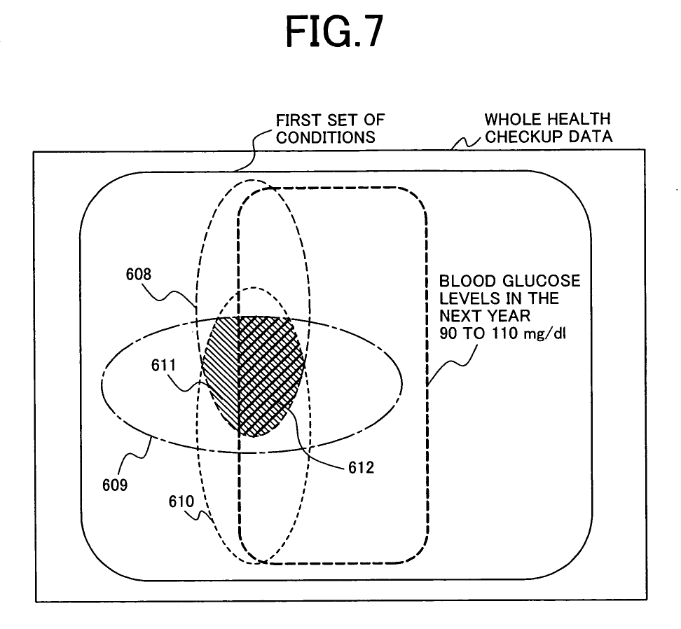

FIG. 7 is a diagram explaining a concept of the data extraction in the embodiment of the present invention and depicts the concept of the extraction at the steps 402 and 403. The numerals 608 to 612 in FIG. 7 correspond with the numerals 608 to 612 in FIG. 6.

FIG. 6 shows an extraction number 601, a first set of extraction conditions (602 to 607), a second set of conditions (608 to 610), the number of examinees corresponding to data satisfying the first and the second set of conditions 611, the number of examinees corresponding to data satisfying the first and the second set of conditions as well as a target blood glucose level of 90 to 110 mg/dl in the next year 612, and an attainment level 613 that indicates the ratio of 612 to 611.

The concept of the extraction is explained below. With the use of the basic information (602 and 603), the current level of laboratory data (604), and the current levels of other items (605 to 607) input at the step 401 by the user as the first set of conditions, health checkup data of examinees satisfying all of the first set of conditions in the first examination year is extracted from the health checkup data storage 103. This result is indicated by the extraction number “0” in the example shown in FIG. 6, and the number of the corresponding examinees is shown to be 950.

Next, health checkup data of examinee satisfying the second set of conditions in the next year is extracted from the health checkup data of the examinees satisfying the first set of conditions taking all combinations of other item levels (608 to 610) into account as the second set of conditions. In the example shown in FIG. 6, the number of the examinees corresponding to BMI of 23 to 25, drinking frequency of one to four times, and no snacking in the next year is shown to be 32 from the extracted result indicated by the extraction number “28”.

Then, health checkup data of examinees satisfying the target level (612) of the laboratory data in the next year is extracted from the health checkup data of the examinees satisfying both the first and the second sets of conditions. In the example shown in FIG. 6, the number of the examinees corresponding to blood glucose level of 90 to 110 mg/dl, BMI of 23 to 25, drinking frequency of one to four times, and no snacking in the next year is shown to be 23 from the extracted result indicated by the extraction number “28”, and it is shown that the target blood glucose level input by the user is satisfied at a ratio of 23/32=71.9% among the examinees satisfying both the first and second sets of conditions.

In other words, the ratio represented by the attainment level 613 indicates a track record of attainment level concerning to what extent the target laboratory data level input by the user was attained when other items (the second set of conditions) are varied based on the achievements of past examinees who were in a health state similar to that of the present user (the first set of conditions).

Next, the control unit 101 activates the display unit 107 and executes a step of displaying result 404 in which the highest attainment level and the second set of conditions at that time are output on the input/output terminal 110 based on the results extracted at the step 402 and the attainment levels computed at the step 403.

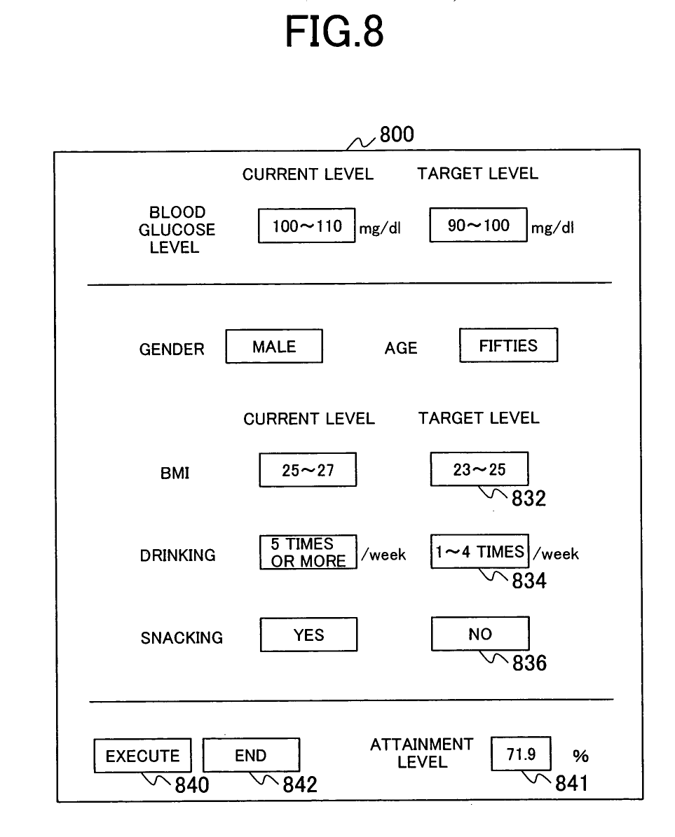

FIG. 8 is a diagram showing a display example of results obtained by the system of the embodiment of the present invention, where a screen example 800 of the input/output terminal 110 after having executed the step 404 is shown.

In the screen example 800, an attainment level computed at the step 403 is displayed in an output column for attainment level 841. Further, the second set of conditions (BMI of 23 to 25, drinking frequency of one to four times per week, no snacking) satisfying this attainment level are displayed, based on the results extracted at the step 402, in columns 832, 834, and 836, respectively, as the target levels of other items. In this way, how much an expected value attainable for the target laboratory data changes depending on how other items and the like are varied can be clearly provided to the user, and the highest attainment level for the target laboratory data level and future levels of other items to satisfy that level are presented based on the achievements of the past examinees who were in a health state similar to that of the user.

Then, the control unit 101 executes a step of determining completion 405. When the user presses an end button 842 in the screen example 800, the system is terminated. When the user does not press the end button 842, the system returns to a state in which new input of conditions can be accepted by reverting to the step 401.

In the embodiment, the attainment level is displayed in ratio, but the number of the extracted examinees may be displayed instead. Thereby, on what database and on what ground the achievements of improvement of the past examinees are extracted can be clearly presented to the user.

Further, in the embodiment, the health checkup data in the first examination year as the first set of conditions and the health checkup data in the next year as the second set of conditions were extracted, respectively. However, the health checkup data in years other than these years may be extracted, thereby making it possible to compute attainment levels such as those after one year and two years depending on various extraction conditions.

Still further, in the screen example 800, the user may input arbitrary values in the input/output columns for other items 832, 834, and 836 and then output, by pressing an execute button 840, an attainment level with other items input as the second set of conditions based on the extraction results as shown in FIG. 6. In this way, the user can vary input values for other items in consideration how far the user can change his/her life style in future and so on. While comparing the attainment levels obtained at that time, the user can utilize these to set up a target of his/her life style toward health improvement.

Still further, in the screen example 300, the user may input arbitrary levels in all input columns (311 to 336) and then output, by pressing the execute button 340, an attainment level when data is extracted by the method as described in the explanation of the step 402 using the basic information (321 and 322), the current level of laboratory data (311), the current levels of other items (331, 333, and 335) as the first set of conditions and a combination of the target levels of other items (332, 334, and 336) as the second set of conditions. In this way, the user can input arbitrary levels for other items in consideration how far the user can change his/her life style in future and so on. While comparing the attainment levels obtained at that time, the user can utilize these to set up a target of his/her life style toward health improvement.

Still further, in the screen example 800 of the embodiment, only one future target level of the laboratory data was input. However, a plurality of target levels may also be input. For example, when a user having a blood glucose level of 110 to 120 mg/dl inputs “glucose level of 100 to 110 mg/dl” and “blood glucose level of 90 to 100 mg/dl” as target levels of the laboratory data, the attainment levels and the second set of conditions are output for each of the target level. Thereby the user can realize how much he needs to change other items in accordance with each target level of the laboratory data, and can utilize them to set up a target of his/her life style toward health improvement while comparing the attainment levels output. In addition, in the screen example 800, the system may set up automatically a plurality of target levels of the laboratory data different from the target level input by the user and display the attainment levels corresponding to these levels at the same time.

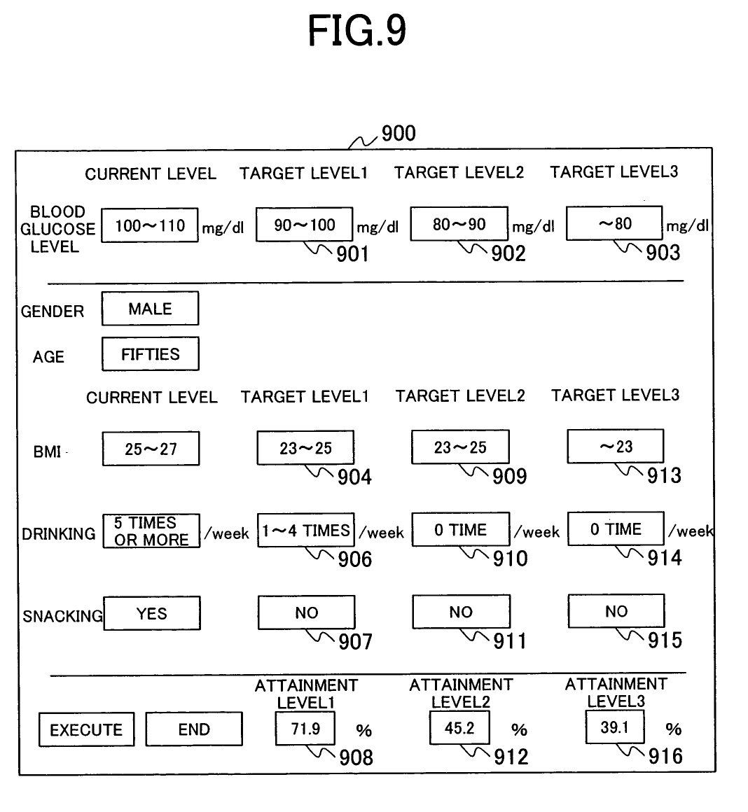

FIG. 9 is a diagram showing another display example of results obtained by the system of the present invention and depicts a screen example 900 of the input/output terminal 110 when a plurality of target levels of the laboratory data and attainment levels thereof are automatically output.

In the screen example 900, a target level 1 (901) is a target level of blood glucose level input by the user, and correspondingly to this, target levels of other items 1 (904 to 907) and an attainment level 1 at that time (908) are displayed. With respect to the target levels of the laboratory data, the system sets up a target level 2 (902) and a target level 3 (903) different from the target level 1 (901) and displays, correspondingly to these target levels, target levels of other items 2 (909 to 911) and an attainment level 2 at that time (912), and target levels of other items 3 (913 to 915) and an attainment level 3 at that time (916), respectively.

In the screen example 900, with respect to the blood glucose level, the system sets up automatically different target levels of “80 to 90 mg/dl” and “less than 80 mg/dl” in response to the target level of “90 to 100 mg/dl” input by the user and displays the target levels of BMI, drinking frequency, and snacking, and the attainment levels at that time for each of the different target levels. Thereby the user can realize how much he needs to change other items in accordance with each target level of the laboratory data. The user can utilize it to set up a target of his/her life style toward health improvement while comparing the output attainment levels.

As the extraction conditions at the step 402 in the embodiment, a range represented by, for example, age in fifties, blood glucose level of 100 to 110 mg/dl, and BMI of 25 to 27 was set up for each item that takes a continuous level. However, the extraction conditions may be set by using fixed levels such as age of fifty, blood glucose level of 105 mg/dl, and BMI of 25.5. Further, for the items that take discontinuous levels such as “smoking-no smoking-smoking stopped”, an extraction condition having an arbitrary combination of levels such as “no smoking or smoking stopped” may also be set. In this way, user convenience can be improved in respect of setting up a target of his/her life style toward health improvement.

Although the highest attainment level and the second set of conditions at that time were output at the step 404 in the embodiment, the second set of conditions may also be output so as to satisfy a designated attainment level that the user or the system has designated arbitrarily in advance. Further, a plurality of second set of conditions may also be output. For example, when “attainment level equal to or higher than 60%” is designated, there is a possibility that a plurality of the second sets of conditions that satisfy the attainment level equal to or higher than 60% may exist, and therefore, all of these may be output. In this way, user convenience can be improved in respect of setting up a target of his/her life style toward health improvement.

Still further in the embodiment, the extraction conditions were set according to the input by the user at the step 401, and data of examinees corresponding to the conditions was extracted from the health checkup data storage 103 at the step 402; however, results extracted in advance using all possible combinations of the first set of conditions and the second set of conditions are prepared in a table, and this may be stored in the health checkup data storage 103. In this way, time required for the data extraction at the step 402 and the computation of attainment level at the step 403 can be reduced to a significant degree.

Furthermore, based on the target levels of other items output at the step 404, additional information to realize these targets may be presented.

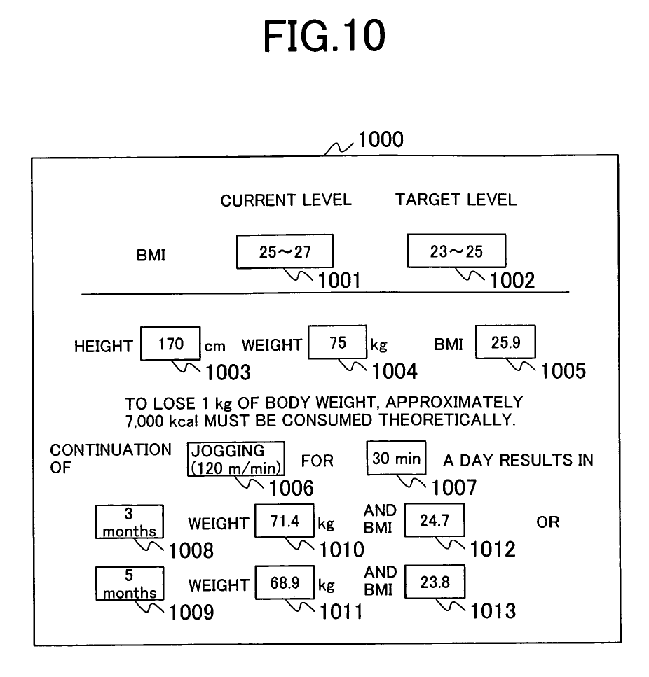

FIG. 10 is a diagram showing still another display example of results obtained by the system of the embodiment of the present invention and depicts a screen example 1000 of the input/output terminal 110 when additional information on BMI is presented.

In the screen example 1000, a current level of BMI 1001 input by the user and its target level 1002 input by the user or extracted by the system, height 1003 of the user, weight 1004 of the user, and kind of exercise 1006, exercise time 1007, and periods of its duration 1008 and 1009 that are all automatically computed to satisfy the target level 1002 based on a BMI 1005 computed from the height and weight of the user are displayed. At the same time, theoretical weights 1010 and 1011 and theoretical BMIs 1012 and 1013 that are computed assuming that the above exercise has been practiced are displayed. Such processing and displaying functions can be readily realized by storing a table correlating calories with exercises in the health checkup data storage 103 in advance. In the example shown in FIG. 10, the content of exercise or the like was displayed by making use of the relation between calories and exercises, while the content of meals or the like may also be displayed by making use of the relation between calories and meal menus. Concerning life style such as drinking and smoking in addition to BMI, contents of a program to stop drinking, a program to stop smoking, and the like, and links to Web pages may also be displayed. By means of such processing and displaying functions, more specific information on how the target levels of other items can be achieved may be provided to the user.

Although health checkup information was used in the system explained above, information is not limited to this. The system of the present invention can be applied to systems in a wide field such as a meal menu decision support system that offers contents of meals to achieve a target health level by making use of past records on meal contents and changes in health level (blood glucose levels of diabetes patients undergoing dietary control by a nutritionist and the like) associated with the meal contents and a fitness menu decision support system that offers contents of exercises to achieve a target health level by making use of past records on exercise contents and changes in health level (body weights of fitness club users practicing a diet menu, and the like) associated with the exercise contents.

As described above, the present invention makes it possible to provide objective information on what life style changes bring about how much improvement in health condition among past examinees showing a health condition similar to that of a user based on accumulated health checkup information, thereby allowing health guidance support for an advising doctor as well as target setting support for life style of an examinee. Further, it is possible to boost strong awareness of life style of the examinee by providing specific improvement results on the basis of actual data. Still further, a system to support disease prevention and health promotion more effectively, where an individual health management program based on actual data is offered by individually extracting specific factors that possibly link to signs of life style diseases as well as improvement of health conditions with the use of health checkup data and so on, can be realized.

As described in the foregoing, the present invention can provide a healthcare support guidance system that offers objective and specific information useful for improvement of health condition of an examinee by extracting past records regarded as showing improvement of health conditions based on laboratory data contained in a large volume of health checkup information accumulated in the past, information on diagnostic results by doctors, and the like.

According to the present invention, the healthcare support guidance system that offers objective and specific information useful for improvement of health condition of an examinee can be provided.

What is claimed is:

1. A health guidance support system comprising:
a health checkup data storage to store health checkup data of a plurality of examinees containing health levels concerned with health conditions or development of diseases and risk data concerned with one or more kinds of risks having an influence on the health conditions or the diseases;
an input unit to input a health level and risk data in the present condition of a user and a future target health level for the health level;
an extraction unit that extracts, with the use of the health checkup data collected at a preceding time point and a subsequent time point with a certain time interval, health checkup data satisfying the health level and the risk data in the present condition of the user at the preceding time point as a first group of data and health checkup data contained in the first group of data and satisfying the target health level at the subsequent time point as a second group of data;
a computing unit to compute an attainment level of the target health level corresponding to a combination of the risk data at the subsequent time point based on the first group of data and the second group of data; and
a display unit to display the combination of the risk data and the attainment level.

2. The health guidance support system according to claim 1, wherein the health level includes laboratory data of examination items relating to the health conditions or the development of diseases.

3. The health guidance support system according to claim 2, wherein the risk includes laboratory data of second examination items that influence the health conditions or the diseases but are different from the examination items.

4. The health guidance support system according to claim 1, wherein the risk includes life style that influences the health conditions or the diseases.

5. The health guidance support system according to claim 4, wherein the disease includes life style diseases caused by the life style.

6. The health guidance support system according to claim 1, wherein the attainment level is a ratio of the number of examinees of the first group of data satisfying the combination of the risk to the number of examinees of the second group of data satisfying the combination of the risk.

7. The health guidance support system according to claim 1, wherein the display unit displays the number of examinees of the first group of data satisfying the combination of the risk and the number of examinees of the second group of data satisfying the combination of the risk at the same time.

8. The health guidance support system according to claim 1, wherein the display unit automatically displays information relating to changes from the risk data in the present condition of the user to the risk data constituting the combination.

9. A health guidance support system comprising:
a health checkup data storage to store health checkup data of a plurality of examinees containing health levels concerned with health conditions or development of diseases and risk data concerned with one or more kinds of risks having an influence on the health conditions or the diseases;
an input unit to input a health level and risk data in the present condition of a user, a future target health level for the health level, and future target risk data for the risk data;
an extraction unit that extracts, with the use of the health checkup data at a preceding time point and a subsequent time point with a certain time interval, health checkup data that satisfies the health level and the risk data in the present condition of the user at the preceding time point as well as the target risk data at the subsequent time point as a first group of data and health checkup data that is contained in the first group of data and satisfies the target health level at the subsequent time point as a second group of data;
a computing unit to compute an attainment level of the target health level based on the first group of data and the second group of data; and
a display unit to display the attainment level.

10. The health guidance support system according to claim 9, wherein the health level includes laboratory data of examination items relating to the health conditions or the development of diseases.

11. The health guidance support system according to claim 9, wherein the risk includes laboratory data of second examination items that influence the health conditions or the diseases but are different from the examination items.

12. The health guidance support system according to claim 9, wherein the risk includes life style that influences the health conditions or the diseases.

13. The health guidance support system according to claim 12, wherein the diseases include life style diseases caused by the life style.

14. The health guidance support system according to claim 9, wherein the attainment level is a ratio of the number of examinees of the first group of data to the number of examinees of the second group of data.

15. The health guidance support system according to claim 9, wherein the display unit displays the number of examinees of the first group of data and the number of examinees of the second group of data at the same time.

16. The health guidance support system according to claim 9, wherein the display unit displays automatically displays information relating to changes from the risk data in the present condition of the user to the target risk data.
